(19) United States
(12) Patent Application Publication
(10) Pub. No.: US 2014/0278120 A1
(43) Pub. Date: Sep. 18, 2014

(54) METHODS AND SYSTEMS FOR LOCATING SEISMIC EVENTS

(71) Applicant: ION Geophysical Corporation, Houston, TX (US)

(72) Inventors: Daniel S. Kahn, Houston, TX (US); Michael E. Glinsky, Houston, TX (US)

(73) Assignee: ION Geophysical Corporation, Houston, TX (US)

(21) Appl. No.: 14/205,716

(22) Filed: Mar. 12, 2014

Related U.S. Application Data
(60) Provisional application No. 61/777,317, filed on Mar. 12, 2013.

(51) Int. Cl. G01V 1/30; G01V 1/28

(52) U.S. Cl. CPC G01V 1/305; G01V 1/282
USPC 702/18

(57) ABSTRACT

Embodiments of locating seismic events are disclosed. In one embodiment, a single difference seismic locator and a reverse double difference seismic locator are combined into a combined system of equations, and the combined system of equations is solved to determine a location of the seismic event in substantially real time relative to the seismic event. The combined system of equations may be weighted such that the determined location of the seismic event is partially influenced by the single difference seismic locator and partially influenced by the reverse double difference seismic locator.

### CROSS REFERENCE TO RELATED APPLICATIONS

This application claims priority to and the benefit of U.S. provisional application No. 61/777,317 entitled “Seismic Event Visualization,” which was filed on Mar. 12, 2013, and which is hereby incorporated by reference in its entirety for all purposes.

### TECHNICAL FIELD

The present disclosure generally relates to analyzing seismic events, and more particularly to locating seismic events.

### BACKGROUND

Microseismic monitoring is frequently used to monitor hydraulic fracturing operations in order to provide information about the fracturing of the rocks to scientists and engineers. Such information can be used to control ongoing hydraulic fracturing, to help the scientists and engineers understand the likely resources available after the fracturing, to help design future hydraulic fracturing jobs, and so forth. This type of information can be derived from seismic measurements made on the surface and/or buried below the surface—including for example measurements of the motion of the ground responsive to the hydraulic fracturing. The seismic data, however, needs to be analyzed and processed before it can be useful in understanding the reservoir and the fracturing job. For example, the seismic data needs to be parsed to identify individual seismic events, to locate those events, to determine their moment magnitude and moment tensor, and so forth. Each of these different parameters for a given seismic event may be determined using various techniques. Usually, however, some degree of uncertainty accompanies each determination of each parameter due to a number of factors. For example, the process of determining the location of a seismic event may be highly dependent on the velocity model used by the locator, which may or may not be accurate.

Once the parameters of a seismic event are known, each seismic event may be visualized to aid interpreters understand the event. Conventional visualization techniques, however, do not provide an indication of the uncertainty associated with the seismic event parameters—such as location, moment magnitude, moment tensor, etc.

### SUMMARY

As described in more detail below, some of the disclosed embodiments provide methods and systems for locating seismic events. In one example method, a method of locating a seismic event includes the acts of receiving a plurality of picked arrival times corresponding to the seismic event at a respective plurality of sensor locations, constructing a first system of equations for locating the seismic event based on a plurality of calculated travel times derived from an estimated velocity model and the plurality of picked arrival times, constructing a second system of equations for locating the seismic event based on relative differences between two or more picked arrival times of the plurality of picked arrival times, the two or more picked arrival times corresponding to two or more of the plurality of sensor locations and relative differences between two or more calculated travel times of the plurality of calculated travel times, the two or more calculated travel times corresponding to two or more of the plurality of sensor locations, and simultaneously solving the first and second systems of equations to determine a location of the seismic event.

In some embodiments, the first and second systems of equations may be simultaneously solved to reduce residual differences between the plurality of picked arrival times and the plurality of calculated travel times associated with the first system of equations, as well as residual differences between the two or more picked arrival times of the plurality of picked arrival times corresponding to two or more of the plurality of sensor locations and the two or more calculated travel times of the plurality of calculated travel times corresponding to two or more of the plurality of sensor locations associated with the second system of equations. The first and second systems of equations may be simultaneously solved by iteratively changing a proposed location for the seismic event until a change in the residual differences is less than a threshold.

In some embodiments, the first and second systems of equations may be weighted for respective influences of the first and second systems of equations on the determined location. The location of the seismic event may include an absolute position within a subsurface region and an origin time, and the plurality of picked arrival times may correspond to a plurality of observed arrival times at the plurality of sensor locations. The first system of equations may represent an absolute seismic event locator such as a single difference locator, and the second system of equations may represent a relative seismic event locator such as a reverse double difference locator.

In some embodiments, the plurality of sensor locations may be located in a plurality of wellbores, the plurality of wellbores forming a buried array. The first system of equations may be represented by a first matrix, the second system of equations may be represented by a second matrix, and the first and second matrices may be combined into a combined matrix before said simultaneous solving. The first and second systems of equations may additionally be weighted by multiplying the combined matrix by a diagonal weighting matrix.

In some embodiments, said simultaneous solving to determine the location of the seismic event may be done in substantially real time relative to the seismic event. Also, in some embodiments, Cook's distance for each of the plurality of picked arrival times may be calculated as a function of the influence of each of the plurality of picked arrival times in locating the seismic event in a first iteration of said simultaneously solving. Picked arrival times with a Cook's distance greater than a threshold may be removed, and the first and second systems of equations may be simultaneously solved in a second iteration while excluding the removed arrival times. In some embodiments, the estimated velocity model may be updated based on the determined location and/or a characterization of the seismic event.

Another example method of locating a seismic event may include the acts of combining a single difference seismic locator and a reverse double difference seismic locator into a combined system of equations, and solving the combined system of equations to determine a location of the seismic event in substantially real time relative to the seismic event, where the combined system of equations is weighted such that the determined location of the seismic event is partially influenced by the single difference seismic locator and partially influenced by the reverse double difference seismic locator.

In some embodiments, the reverse double difference seismic locator may influence the determined location of the seismic event based on relative differences between picked arrival times and calculated travel times for two or more of a plurality of seismic sensors positioned proximate one another. The plurality of seismic sensors may be positioned in a vertical wellbore, a first of the plurality of seismic sensors may be positioned no more than 20 meters away from a second of the plurality of seismic sensors, and a third of the plurality of seismic sensors may be positioned no more than 20 meters away from the second of the plurality of seismic sensors. Furthermore, in some embodiments, a graphical representation of the seismic event may be displayed that varies in time based on an uncertainty associated with the determined location of the seismic event, the graphical representation varying in time by moving within an enclosed space representing a bounded volume in which the seismic event is expected to have occurred based on the determined location and the uncertainty.

Another example of a method for locating a seismic event may include the acts of receiving a plurality of picked arrival times corresponding to the seismic event at a respective plurality of sensor locations, the plurality of sensor locations defining a 3-D buried array, calculating a plurality of travel times derived from an estimated velocity model, constructing a system of equations for locating the seismic event based on relative differences between two or more picked arrival times of the plurality of picked arrival times, the two or more picked arrival times corresponding to two or more of the plurality of sensor locations and relative differences between two or more calculated travel times of the plurality of calculated travel times, the two or more calculated travel times corresponding to two or more of the plurality of sensor locations, and solving the systems of equation to determine a location of the seismic event.

As is also described in more detail below, some of the disclosed embodiments provide methods and systems for visualizing seismic events. One example of a system for visualizing a seismic event includes a processor configured to receive a first parameter related to the seismic event and a first uncertainty associated with the first parameter, and a display coupled to the processor and configured to provide a time-varying graphical representation of the seismic event responsive to instructions from the processor, the graphical representation varying in time based on the first uncertainty associated with the first parameter.

In some embodiments, the graphical representation may include a 3-D object, such as a sphere or a radiation pattern associated with the seismic event. The first parameter may include a determined spatial position associated with the seismic event and the graphical representation may vary in time by moving within an enclosed space. The enclosed space may include a bounded volume in which the seismic event is expected to have occurred, the uncertainty associated with the determined spatial position defining outer limits of said bounded volume.

In some embodiments, the first parameter comprises a moment magnitude associated with the seismic event and the graphical representation may vary in time by expanding and contracting. The uncertainty associated with the moment magnitude of the seismic event may determine an amount of expansion and contraction of the graphical representation, and an average size of the graphical representation may correspond to a most likely moment magnitude associated with the seismic event.

In some embodiments, the first parameter may include a moment tensor associated with the seismic event, the graphical representation may include a sphere, and the graphical representation may vary in time by showing motion of one or more indications on the sphere, with the motion of the one or more indications on the sphere being a function of the first uncertainty associated with the moment tensor. At least one of the one or more indications may include one of a line or a colored region.

In some embodiments, the graphical representation may include a first graphical representation, and the processor may be further configured to receive a second parameter related to the seismic event and a second uncertainty associated with the second parameter, with the display further configured to combine a second graphical representation with the first graphical representation responsive to instructions from the processor. The display may be configured to overlay the second graphical representation onto the first graphical representation.

In some embodiments the second parameter may include one or more values associated with a moment tensor of the seismic event. The second graphical representation may include a sphere with at least a first region defining a first color, a second region defining a second color, and a transition region between the first and second regions defining a third color, the third color being a combination of the first and second colors, and a size of the transition region determined based on the second uncertainty associated with the moment tensor. The second graphical representation may include a beach ball with a plurality of different regions, with one or more transitions between the plurality of different regions of the beach ball being blurred based on the second uncertainty. The moment tensor may include a plurality of components, and the second graphical representation may show a first of the plurality of components of the moment tensor during a first time slot and a second of the plurality of components of the moment tensor during a second time slot. Alternatively, the second graphical representation may translucently show two or more of a plurality of components of the moment tensor.

In some embodiments, the processor may be further configured to receive a second parameter related to the seismic event and a second uncertainty associated with the second parameter, the processor further configured to provide instructions to the display to vary the graphical representation in time based on a union of the first and second parameters with the corresponding first and second uncertainties. The processor may be further configured to selectively provide instructions to the display to stop the graphical representation from varying in time with respect to the first and/or second parameter.

Another example of a system for visualizing a plurality of seismic events includes a processor configured to receive a plurality of parameters related to respective ones of the plurality of seismic events, and a display coupled to the processor and configured to provide a plurality of graphical representations corresponding to the plurality of seismic events responsive to instructions from the processor, one or more of the plurality of graphical representations varying in time based on uncertainties associated with one or more of the plurality of parameters.

In some embodiments, the processor may be further configured to provide instructions to the display to selectively hide one or more of the plurality of graphical representations based on a filtering criteria, and/or the graphical representations corresponding to the plurality of seismic events may be provided on the display as each of the plurality of seismic events occurs in substantially real-time.

Another example of a system for visualizing a seismic event includes a processor configured to receive a first parameter related to the seismic event and a first uncertainty associated with the first parameter, and a display coupled to the processor and configured to provide a graphical representation of the seismic event with at least one feature of the graphical representation being blurred as a function of the first uncertainty associated with the first parameter.

In some embodiments, the first parameter may include a moment tensor related to the seismic event, the graphical representation may include a plurality of regions, and the at least one feature may include a transition between two or more of the plurality of regions, with the transition being blurred as a function of the first uncertainty. A thickness of the transition may be based on the first uncertainty, and the thickness of the transition may not vary in time. Also, in some embodiments the processor may be further configured to receive a moment magnitude related to the seismic event, a second uncertainty associated with the moment magnitude, a determined location of where the seismic event likely occurred, and a third uncertainty associated with the determined location, the display being further configured to vary the graphical representation in time based on the second and third uncertainties.

### BRIEF DESCRIPTION OF THE DRAWINGS

FIG. 1 is a simplified diagram of a microseismic monitoring operation during a hydraulic fracturing job.

FIG. 2 is a flow chart illustrating a method for analyzing seismic events.

FIG. 3 is a simplified block diagram of a computer system which may be used to implement various embodiments of the invention described herein.

FIGS. 4A and 4B are flow charts illustrating methods for locating a seismic event.

FIGS. 5A through 5D illustrate one embodiment of visualizing a seismic event.

FIGS. 6A through 6D illustrate one embodiment of visualizing a seismic event.

FIGS. 7A through 7D illustrate one embodiment of visualizing a seismic event.

FIG. 8 illustrates one embodiment of visualizing a seismic event.

FIGS. 9A through 9C illustrate one embodiment of visualizing a seismic event.

FIG. 10 illustrates one embodiment of visualizing a seismic event.

FIG. 11 illustrates a computer display showing multiple seismic events.

### DETAILED DESCRIPTION

Understanding the nature and characteristics of a seismic event (such as a microseismic event) may involve determining a location, a moment magnitude, and a moment tensor corresponding to the seismic event. In some embodiments disclosed herein, the location may be determined by combining a single difference type locator with a reverse double difference type locator. The single difference locator is an absolute locator, whereas the reverse double difference locator is a relative locator. By weighting the contributions of the single difference and reverse double difference locators, an improved absolute location of seismic events can be determined.

Based on the determined location, a determined moment magnitude, and/or a determined moment tensor, the seismic event may be visually represented, for example on a computer screen, as a bouncing ball in an enclosed space. The enclosed space may represent the boundaries within which the event is expected to have occurred. In one example, the enclosed space may be a cube or ellipsoid, however, in alternative embodiments, any reasonable shape of enclosed space may be used. The size of the ball may depend on the moment magnitude of the event. In one embodiment, the ball may be visually represented as having a changing shape. For example, the size of the ball may be shown as expanding and contracting. The amount of expansion and contraction of the ball may represent an uncertainty in the estimation of the moment magnitude.

Additionally, the ball may be shown with features that represent the moment tensor. In general, the moment tensor may indicate the type of seismic event. For example, the moment tensor may indicate the fault lines, the orientation of slipping, the amount of volume expansion/contraction, and the like. Embodiments of the invention thus facilitate real-time or near real-time visualization of seismic activity. This may be useful, for example, while conducting hydraulic fracturing operations to determine effectiveness of fracking, qualities of the target areas, safety of continuing fracking operations, and the like.

Turning now to the figures, FIG. 1 illustrates a seismic monitoring system 100. The system 100 includes a hydraulic fracturing well 102, along with a plurality of monitoring wells 104 (which may be referred to as boreholes). Each monitoring well 104 includes a plurality of sensor stations 106 (e.g., geophones, accelerometers, etc.), which may be spaced for example 20 meters apart. The monitoring wells 104 may also be spaced 20 meters apart in some embodiments. Once the sensors 106 are positioned in the monitoring wells 104, the wells 104 are usually filled in provide good coupling between the subsurface and the sensors 106. It should be noted that in some embodiments, instead of monitor wells, the sensors 106 may be spread out in a grid on the surface above the fracturing well 102. In still other embodiments, a single monitoring well 104 may be used, or a plurality of monitoring wells 104 may be used, as illustrated in FIG. 1. In those instances where multiple monitoring wells 104 are used, the monitoring wells 104 may form a grid over an area of interest, or they may only form a line of wells 104 at a specific region near the hydraulic fracturing well 102. Furthermore, while reference is generically made herein to seismic events, it will be understood that the concepts and disclosure may also apply many types of endeavors—including hydraulic fracturing microseismic monitoring, non-hydraulic fracturing microseismic monitoring, active source seismic prospecting (including on land or at sea), earthquake seismology, and so forth.

Referring now to FIG. 2, an overview of a method 200 to analyze one or more seismic events is shown. The method 200 may be carried out in real-time or in near-real time during, for example, a hydraulic fracturing job. The method 200 shown in FIG. 2 is intended as an overview, and specific details regarding certain steps will be described in more detail below.

In operation 202, seismic data may be received and pre-processed. The seismic data may be motion and/or pressure measurements from one or more sensors, such as geophones, accelerometers, hydrophones (in a marine environment), and so forth. The sensors may be positioned in one or more monitoring well boreholes, be spread across the surface of the earth proximate an area of interest, towed behind a vessel, etc. Pre-processing the data may include rotating motion measurements, removing noise, stacking, and other processing steps.

In operation 204, pick times for one or more seismic events may be determined. Pick times may be determined by an automated process that analyzes neighboring traces to find a common event using semblance or cross-correlation techniques in some embodiments. The pick times, together with a velocity model and the physical locations of the sensors (including, where relevant the locations of the monitoring well boreholes) may be used to determine the location of the event in operation 206. The location of the event may include its spatial location (x, y, and z coordinates) within the subsurface and also the time at which the event occurred. The time may be an origin time, and may be relative. In operations 208 and 210, the moment magnitude and moment tensor associated with each event are determined, and in operation 212, the location, the moment magnitude, and/or the moment tensor may be used to visualize the event. In operations 206, 208, and/or 210, an uncertainty of the determined location, moment magnitude, and/or moment tensor may also be calculated or provided, and in operation 212, such uncertainties may be visualized together with a graphical representation of one or more parameters associated with the seismic event.

The method 200 may be repeated for many events and/or many events may proceed through operations 202-212 in parallel. It will be appreciated that in various embodiments, the operations 202-212 need not all be done together. For example, if the location, moment magnitude, and/or moment tensor parameters are already known (e.g., via conventional methods or other methods not described herein), these parameters could be used in the visualization operation 212. Alternatively, these parameters could be calculated but never visualized (or could be visualized in a manner not described herein). In general, while method 200 has been described with reference to FIG. 2 as an overview of a seismic monitoring process, each of the various operations described in more detail below may be carried out independent of the other operations in some instances.

FIG. 3 illustrates an exemplary computer system 300, which may be used to perform one or more of the operations in method 200. As illustrated in FIG. 3, the computer system 300 may include at least one Central Processing Unit (CPU) 311, a memory 312, data storage 316, input/output device 317, and network interface device 319. While a single CPU 311 is shown in FIG. 3, in alternative embodiments, a plurality of CPUs may be implemented within the computer system, or multiple computer systems may be combined as a processing cluster.

The input/output device 317 may include devices such as a mouse, keyboard, trackball, stylus pen, touchscreen, display (e.g., computer monitor), and the like. The network interface device 319 may be any entry/exit device configured to allow network communications between the computer system 300 and another device, e.g., another computer system, a server, and the like. In one embodiment, the network interface device 319 may be a network adapter or other network interface card (NIC).

Data storage 316 may be a Direct Access Storage Device (DASD). Although it is shown as a single unit, it could be a combination of fixed and/or removable storage devices, such as fixed disc drives, floppy disc drives, tape drives, removable memory cards, or optical storage. The memory 312 and data storage 316 could be part of one virtual address space spanning multiple primary and secondary storage devices.

The memory 312 may be a random access memory that is sufficiently large to hold the necessary programming and data structures of the invention. While memory 312 is shown as a single entity, it should be understood that memory 312 may in fact comprise a plurality of modules, and that memory 312 may exist at multiple levels, from high speed registers and caches to lower speed but larger DRAM chips. Illustratively, the memory 312 may include an operating system 313. Any operating system supporting the functions disclosed herein may be used.

Memory 312 may also include a location program 322 and a visualization program 323 which, when executed by CPU 311, enable the location and visualization of seismic events as described herein. Generally speaking, the memory may include one or more programs configured to determine the location, moment tensor, and moment magnitude of a seismic event based on seismic data stored in the memory and/or storage, and to render a visual image or animation of the seismic event as described herein on a display device.

### Locating Seismic Events

Referring now to FIGS. 4A and 4B, embodiments for determining the location of a seismic event (e.g., operation 206 in the method 200 shown in FIG. 2) will now be described.

Conventional techniques for locating seismic events generally fall into two categories: 1) absolute locators which locate events with respect to fixed coordinates but are subject to errors in the velocity model, and 2) relative locators which locate events with respect to each other. While relative locators tend to cancel the errors in the velocity model, they typically can only be used after many events have been gathered, and therefore cannot provide real time data or data on a per event basis. As described in more detail below, a novel method for determining the location of a seismic event generally involves combining a relative locator, such as a reverse double difference (RDD) locator, with an absolute locator, such as a single difference (SD) locator, such that the two locators are run simultaneously. In general, RDD locators cluster multiple receiver stations or sensors for the same event as opposed to traditional double difference (DD) locators, which cluster multiple events for a single receiver station or sensor. Matrices describing RDD may therefore be combined with matrices describing an absolute locator (such as a single difference locator), thereby producing a combined matrix which can be solved in a single operation. In another embodiment described below, an RDD type locator may be used with data obtained from a 3D buried array of sensors.

In an SD non-linear least squares locator, we seek to minimize

$${\sum }_{k} {( {t}_{k}^{obs , i} - t ( {S}_{k} , {R}^{i} ) )}^{2} \qquad Equation 1$$

where tₖ^{obs,j} is the observed arrival time at sensor k from event i, and t is the calculated travel time at Sₖ (the location of sensor k) for Rⁱ (the estimated location of event i). In other words, we seek to minimize the sum (over one or more sensor locations k) of the square of the difference between observed arrival times and calculated travel times. The inputs to this SD locator include pick times and the velocity model. The velocity model may be used to calculate travel times from each subsurface point to the position of each sensor k. The travel times may thus be calculated on a grid and interpolated between grid points.

The relationship between the calculated travel time, t, and the event location, R, in Equation 1 is highly nonlinear, so a truncated Taylor series expansion can be used to linearize the results. For a single borehole monitor well with four sensors, this leads to

$$( \begin{matrix}\frac{\partial {t}_{1}^{i}}{\partial x} & \frac{\partial {t}_{1}^{i}}{\partial y} & \frac{\partial {t}_{1}^{i}}{\partial z} & 1 \\ \frac{\partial {t}_{2}^{i}}{\partial x} & \frac{\partial {t}_{2}^{i}}{\partial y} & \frac{\partial {t}_{2}^{i}}{\partial z} & 1 \\ \frac{\partial {t}_{3}^{i}}{\partial x} & \frac{\partial {t}_{3}^{i}}{\partial y} & \frac{\partial {t}_{3}^{i}}{\partial z} & 1 \\ \frac{\partial {t}_{4}^{i}}{\partial x} & \frac{\partial {t}_{4}^{i}}{\partial y} & \frac{\partial {t}_{4}^{i}}{\partial z} & 1\end{matrix} ) ( \begin{matrix}Δ {x}^{i} \\ Δ {y}^{i} \\ Δ {z}^{i} \\ Δ {τ}^{i}\end{matrix} ) \approx ( \begin{matrix}{r}_{1}^{i} \\ {r}_{2}^{i} \\ {r}_{3}^{i} \\ {r}_{4}^{i}\end{matrix} ) \qquad Equation 2$$

In Equation 2, the superscript i refers to the event number, and the subscripts 1 to 4 refer to the sensor locations. Δx, Δy, and Δz refer to the event position and Δτ refers to the origin time. Each t in the matrix can be considered as either the calculated arrival time or the calculated travel time (because the arrival time is simply the travel time plus the origin time). In the event additional sensors or additional monitoring well boreholes are used, additional rows can be added to the bottom of the left-most matrix. The right-most column of the left-most matrix includes all 1s because the partial derivative of the arrival/travel time with respect to origin time is 1. Referring still to Equation 2, the rⱼⁱ are the differences between observed and calculated arrival/travel times.

The solutions for Equation 2 may be found through an iterative least-squares process. For each iteration, an estimated location (which includes the x, y, z position and the origin time τ) of the event location is updated, and the matrix equation is solved for the location correction. By adjusting the location until the change is below a given threshold, a final location can be determined.

It will be appreciated that the derivatives which appear in the matrix and the time differences (rⱼⁱ) depend on the velocity model because the velocity model controls the speed at which seismic waves from a seismic event propagate through the subsurface. If the velocity model used does not accurately represent the subsurface, then the observed times and the calculated times may not be minimized for the actual seismic event location. Further, note that, in some embodiments, we calculate travel times and compare them to picked arrival times, which as previously mentioned, differ by the origin time.

Still referring to Equation 2, the equation is solved iteratively in the least squares sense until a fixed solution is reached—e.g., until the change from one iteration to the next is less than a specified tolerance, or until the change in the standard deviation of the rⱼⁱs is less than a specified tolerance.

In contrast, a conventional DD locator can be represented as follows:

drₖ^{ij}≡(tₖⁱ−tₖ^{j})^{obs}−(tₖⁱ−tₖ^{j})^{cal} Equation 3

In Equation 3, relative differences between closely clustered event locations are minimized (with respect to a single receiver station or sensor) with the rationale being that the subsurface paths traveled by closely clustered events will be similar to one another.

In an RDD locator, the principle of reciprocity is used to reverse the conventional DD locator method. Specifically, the RDD technique locates a single event using multiple stations/sensors, as opposed to conventional DD technique where relative differences between multiple events are determined using a single station/sensor. In other words, an RDD locator takes differences of the SD technique for pairs of sensors/stations which influence the best fit location. The use of an RDD locator in a buried array (e.g., the multiple monitor wells 106 illustrated in FIG. 1) may be useful because of the proximity of the sensors 106 within a single borehole and/or among different boreholes. Specifically, and with reference back to FIG. 1, for a given seismic event 108, the paths 110, 111 of seismic waves to two sensors 106A, 106B in a single well 104 may be very similar, and the paths of seismic waves to sensors between wells 104 (not shown) may also be similar. Because the paths are similar, any unaccounted for velocity anomalies may at least partially cancel out (due to the “differencing”) and not affect the determined location of the seismic event. Although the paths 110, 111 are shown as straight lines to simplify the illustration, it will of course be appreciated that the actual propagation of the seismic waves may not be in a straight line. The RDD locator technique takes advantage of the similarities in travel paths of a single seismic event to nearby sensor stations in order to cancel out velocity model errors or inconsistencies.

Note that the RDD locator technique is not limited to use in buried arrays, and can also be used in systems with a grid of sensors on the surface. Usually, however, for any RDD locator technique, at least two sensors/stations need to be positioned relatively close to one another (e.g., within 1, 5, 10, 20, 40, 100 meters) such that seismic waves originating from a common seismic event traverse similar subsurface structures and features in traveling to the two or more sensors/stations.

Referring now to FIGS. 4A and 4B, embodiments of combining RDD locator techniques with SD locator techniques to locate a seismic event will now be described. The RDD locator techniques may be combined with the SD locator techniques to obtain improved location of seismic events (as a result of the velocity model cancelation from the RDD locator) at absolute locations (as a result of the SD locator). Further, this combined locator can be used to locate individual seismic events, and may in some embodiments be carried out in real-time or near real-time (e.g., within seconds or minutes after the seismic event occurs).

Referring specifically now to the method 400 illustrated in FIG. 4A, in one embodiment, a plurality of picked arrival times corresponding to a seismic event at a plurality of sensor locations may be received by a locator (such as the locator program 322 illustrated in FIG. 3) in operation 402. In some embodiments, only P-wave picked arrival times may be used. In other embodiments, S-wave picked arrival times may be used in addition to or instead of P-wave picked arrival times. In those embodiments that use both P and S pick times, two separate velocity models may be needed for subsequent operations, but the combination of both types of pick times may improve the accuracy of the determined location of the seismic event.

In operation 404, a plurality of travel times may be derived from a velocity model. For example, travel times for each of a grid of subsurface locations to one or more sensor locations may be determined and stored in a table.

In operation 406, a first system of equations may be constructed for locating the seismic event based on the picked arrival times from operation 402 and the calculated travel times from operation 404. The first system of equations may represent an absolute seismic event locator, such as the SD locator described above, and may be represented by a first matrix, such as the following:

$$( \begin{matrix}\frac{\partial {t}_{1}}{\partial x} & \frac{\partial {t}_{1}}{\partial y} & \frac{\partial {t}_{1}}{\partial z} & 1 \\ \frac{\partial {t}_{2}}{\partial x} & \frac{\partial {t}_{2}}{\partial y} & \frac{\partial {t}_{2}}{\partial z} & 1 \\ \frac{\partial {t}_{3}}{\partial x} & \frac{\partial {t}_{3}}{\partial y} & \frac{\partial {t}_{3}}{\partial z} & 1 \\ \frac{\partial {t}_{4}}{\partial x} & \frac{\partial {t}_{4}}{\partial y} & \frac{\partial {t}_{4}}{\partial z} & 1\end{matrix} ) [ \begin{matrix}Δ x \\ Δ y \\ Δ z \\ Δ τ\end{matrix} ] \approx [ SD ] \qquad Equation 4$$

Equation 4 is for four sensors in a single monitor well. Additional rows can be added to the left-most matrix in Equation 4 for additional sensors in the same or different monitor wells. Each t in Equation 4 represents the calculated travel time derived from the velocity model for a proposed location

In operation 408, a second system of equations may be constructed for locating the seismic event based on relative differences between two or more picked arrival times of the plurality of picked arrival times (from operation 402) corresponding to two or more of the plurality of sensor locations and relative differences between two or more calculated travel times of the plurality of calculated travel times (from operation 404) corresponding to two or more of the plurality of sensor locations. The second system of equations may represent a relative seismic event locator, such as the RDD locator described above, and may be represented by a second matrix, such as the following:

$$( \begin{matrix}\frac{\partial ( {t}_{1} - {t}_{2} )}{\partial x} & \frac{\partial ( {t}_{1} - {t}_{2} )}{\partial y} & \frac{\partial ( {t}_{1} - {t}_{2} )}{\partial z} & 0 \\ \frac{\partial ( {t}_{1} - {t}_{3} )}{\partial x} & \frac{\partial ( {t}_{1} - {t}_{3} )}{\partial y} & \frac{\partial ( {t}_{1} - {t}_{3} )}{\partial z} & 0 \\ \frac{\partial ( {t}_{1} - {t}_{4} )}{\partial x} & \frac{\partial ( {t}_{1} - {t}_{4} )}{\partial y} & \frac{\partial ( {t}_{1} - {t}_{4} )}{\partial z} & 0 \\ \frac{\partial ( {t}_{2} - {t}_{3} )}{\partial x} & \frac{\partial ( {t}_{2} - {t}_{3} )}{\partial y} & \frac{\partial ( {t}_{2} - {t}_{3} )}{\partial z} & 0 \\ \frac{\partial ( {t}_{2} - {t}_{4} )}{\partial x} & \frac{\partial ( {t}_{2} - {t}_{4} )}{\partial y} & \frac{\partial ( {t}_{2} - {t}_{4} )}{\partial z} & 0 \\ \frac{\partial ( {t}_{3} - {t}_{4} )}{\partial x} & \frac{\partial ( {t}_{3} - {t}_{4} )}{\partial y} & \frac{\partial ( {t}_{3} - {t}_{4} )}{\partial z} & 0\end{matrix} ) [ \begin{matrix}Δ x \\ Δ y \\ Δ z \\ Δ τ\end{matrix} ] \approx [ DD ] \qquad Equation 5$$

Equation 5 is for four sensors in a single monitor well. Additional rows can be added to the left-most matrix in Equation 5 for additional sensors in the same or different monitor wells.

In some embodiments, the first and second matrices (i.e., Equations 4 and 5) may be combined into a combined matrix before operation 410:

$$( \begin{matrix}\frac{\partial {t}_{1}}{\partial x} & \frac{\partial {t}_{1}}{\partial y} & \frac{\partial {t}_{1}}{\partial z} & 1 \\ \frac{\partial {t}_{2}}{\partial x} & \frac{\partial {t}_{2}}{\partial y} & \frac{\partial {t}_{2}}{\partial z} & 1 \\ \frac{\partial {t}_{3}}{\partial x} & \frac{\partial {t}_{3}}{\partial y} & \frac{\partial {t}_{3}}{\partial z} & 1 \\ \frac{\partial {t}_{4}}{\partial x} & \frac{\partial {t}_{4}}{\partial y} & \frac{\partial {t}_{4}}{\partial z} & 1 \\ \frac{\partial ( {t}_{1} - {t}_{2} )}{\partial x} & \frac{\partial ( {t}_{1} - {t}_{2} )}{\partial y} & \frac{\partial ( {t}_{1} - {t}_{2} )}{\partial z} & 0 \\ \frac{\partial ( {t}_{1} - {t}_{3} )}{\partial x} & \frac{\partial ( {t}_{1} - {t}_{3} )}{\partial y} & \frac{\partial ( {t}_{1} - {t}_{3} )}{\partial z} & 0 \\ \frac{\partial ( {t}_{1} - {t}_{4} )}{\partial x} & \frac{\partial ( {t}_{1} - {t}_{4} )}{\partial y} & \frac{\partial ( {t}_{1} - {t}_{4} )}{\partial z} & 0 \\ \frac{\partial ( {t}_{2} - {t}_{3} )}{\partial x} & \frac{\partial ( {t}_{2} - {t}_{3} )}{\partial y} & \frac{\partial ( {t}_{2} - {t}_{3} )}{\partial z} & 0 \\ \frac{\partial ( {t}_{2} - {t}_{4} )}{\partial x} & \frac{\partial ( {t}_{2} - {t}_{4} )}{\partial y} & \frac{\partial ( {t}_{2} - {t}_{4} )}{\partial z} & 0 \\ \frac{\partial ( {t}_{3} - {t}_{4} )}{\partial x} & \frac{\partial ( {t}_{3} - {t}_{4} )}{\partial y} & \frac{\partial ( {t}_{3} - {t}_{4} )}{\partial z} & 0\end{matrix} ) [ \begin{matrix}Δ x \\ Δ y \\ Δ z \\ Δ τ\end{matrix} ] \approx [ \begin{matrix}SD \\ DD\end{matrix} ] \qquad Equation 6$$

By combining the first and second systems of equations for, in this example, four sensors in a single monitoring well borehole, the combined system of equations is essentially taking the differences of the SD differences, or taking differences between sensors within each borehole. While Equation 6 shows differences being taken between 4 sensors within a borehole, it will be understood that differences may be taken between more or fewer sensors within a borehole monitor well and/or between sensors in different borehole monitor wells. To solve for the location (e.g., the x, y, z position and origin time), at least 4 sensors may be used, whether in the same or different monitoring well boreholes, in some embodiments.

Also, in some embodiments, the first and second systems of equations may be weighted by multiplying the combined matrix with a diagonal weighting matrix before operation 410:

$$W ( \begin{matrix}\frac{\partial {t}_{1}}{\partial x} & \frac{\partial {t}_{1}}{\partial y} & \frac{\partial {t}_{1}}{\partial z} & 1 \\ \frac{\partial {t}_{2}}{\partial x} & \frac{\partial {t}_{2}}{\partial y} & \frac{\partial {t}_{2}}{\partial z} & 1 \\ \frac{\partial {t}_{3}}{\partial x} & \frac{\partial {t}_{3}}{\partial y} & \frac{\partial {t}_{3}}{\partial z} & 1 \\ \frac{\partial {t}_{4}}{\partial x} & \frac{\partial {t}_{4}}{\partial y} & \frac{\partial {t}_{4}}{\partial z} & 1 \\ \frac{\partial ( {t}_{1} - {t}_{2} )}{\partial x} & \frac{\partial ( {t}_{1} - {t}_{2} )}{\partial y} & \frac{\partial ( {t}_{1} - {t}_{2} )}{\partial z} & 0 \\ \frac{\partial ( {t}_{1} - {t}_{3} )}{\partial x} & \frac{\partial ( {t}_{1} - {t}_{3} )}{\partial y} & \frac{\partial ( {t}_{1} - {t}_{3} )}{\partial z} & 0 \\ \frac{\partial ( {t}_{1} - {t}_{4} )}{\partial x} & \frac{\partial ( {t}_{1} - {t}_{4} )}{\partial y} & \frac{\partial ( {t}_{1} - {t}_{4} )}{\partial z} & 0 \\ \frac{\partial ( {t}_{2} - {t}_{3} )}{\partial x} & \frac{\partial ( {t}_{2} - {t}_{3} )}{\partial y} & \frac{\partial ( {t}_{2} - {t}_{3} )}{\partial z} & 0 \\ \frac{\partial ( {t}_{2} - {t}_{4} )}{\partial x} & \frac{\partial ( {t}_{2} - {t}_{4} )}{\partial y} & \frac{\partial ( {t}_{2} - {t}_{4} )}{\partial z} & 0 \\ \frac{\partial ( {t}_{3} - {t}_{4} )}{\partial x} & \frac{\partial ( {t}_{3} - {t}_{4} )}{\partial y} & \frac{\partial ( {t}_{3} - {t}_{4} )}{\partial z} & 0\end{matrix} ) [ \begin{matrix}Δ x \\ Δ y \\ Δ z \\ Δ τ\end{matrix} ] \approx W [ \begin{matrix}SD \\ DD\end{matrix} ] \qquad Equation 7$$

W may be a diagonal weighting matrix, which may have a weighting for the SD and RDD parts—for example, the SD portion may be weighted 50% while the RDD may be weighted 50%. The relative weights may change the influence of a certain difference calculation on the overall location determination. Any weighting method may be used, and the weights given to the respective SD and RDD portions may depend on, for example, the known accuracy of the velocity model (e.g., if the velocity model is fairly well known, the SD portion may be more heavily weighted), how close the sensors/stations are (e.g., if the sensors are very close together, the RDD portion may be more heavily weighted), and so forth.

Referring still to Equation 7, it will be appreciated that Equation 7 can be solved for individual seismic events. In other words, unlike conventional DD techniques, the method 100 can be carried out for each individual seismic event, without the need for other seismic events. This of course does not prevent multiple seismic events from being considered together.

In operation 410, the first and second systems of equations may be simultaneously solved to determine a location (e.g., an x, y, z position and an origin time) of the seismic event. The systems of equations may be simultaneously solved to reduce (e.g., minimize, reduce until they are below a certain threshold, etc.) residual differences between the plurality of picked arrival times and the plurality of calculated travel times associated with the first system of equations, as well as residual differences between the two or more picked arrival times (e.g., 4 picked arrival times in Equation 7) of the plurality of picked arrival times corresponding to two or more of the plurality of sensor locations (e.g., 4 sensor stations) and the two or more calculated travel times (e.g., 4 calculated travel times) of the plurality of calculated travel times corresponding to the two or more of the plurality of sensor locations associated with the second system of equations.

In some embodiments, the first and second systems of equations may be simultaneously solved in operation 410 by iteratively changing a proposed location for the seismic event until, for example, a change in the residual differences is less than a threshold. For example, an LSQR algorithm may be used to solve the combined system of equations, or the two systems of equations may be solved separately but the outputs considered simultaneously. Referring back to Equation 7, the Δx, Δy, Δz, and Δτ may refer to corrections to the location (e.g., position and origin time) after each iteration, which are added to the previous location for a subsequent iteration. The iterations may continue until the change in the residual differences is below a specified threshold and/or until the residual differences are minimized to within a certain tolerance.

In some embodiments, during a first iteration, Cook's distances may be computed for each of the picked arrival times based on each picked arrival times' influence in locating the seismic event. Once the Cook's distances for each pick time is computed, any arrivals with a Cook's distance greater than a defined threshold (e.g., outside two standard deviations of the mean Cook's distance) may be removed, and the remaining picked arrival times may be used in the second iteration of the simultaneous solving of operation 410. In some embodiments, Cook's distances may be computed for each sensor/station, and all measurements/picks associated with that station/sensor may be removed.

Referring now to the method 430 illustrated in FIG. 4B, in another embodiment, a single difference seismic locator and reverse double difference locator may be combined into a single, combined system of equations in operation 432.

In operation 434, the combined system of equations (from operation 432) may be solved to determine the location of a seismic event. In some embodiments, the combined system of equations may be solved in substantially real-time relative to the seismic event. Further, as described above, the combined system of equations may be weighted such that the determined location of the seismic even is partially influenced by the single difference seismic locator and partially influenced by the reverse double difference seismic locator.

Methods 400, 430 may be carried out by the locator program 322 illustrated in FIG. 3 in some embodiments. Further, methods 400, 430 may be done in substantially real time relative to the seismic event in some instances, in order to, for example, provide feedback to operators of a hydraulic fracturing job.

A number of operations may be carried out after either method 400 or method 430 is used to locate a seismic event in some embodiments. As one example, an estimated velocity model may be updated based on a determined location and characterization (e.g., moment magnitude, moment tensor, etc.) of one or more seismic events. This may be useful because in, for example, a hydraulic fracturing job, each seismic event may correspond to the fracturing of shale, which may change the subsurface reservoir. Changes in the subsurface reservoir may necessitate changes in the velocity model, as the changes may alter the path along which seismic waves propagate towards the surface.

Furthermore, it will be appreciated that other variations could be made to the methods for locating a seismic event described above. In some embodiments, for example, an RDD locator alone (i.e., without being combined with an absolute locator such as SD) may be used on data obtained from a 3D buried array of sensors. The 3D buried array of sensors may include a plurality of monitor wells 104 (in FIG. 1) that define an array over the surface of the earth. The high density of receivers in such a 3D buried array of sensor locations (in all three coordinate directions) may be used by the RDD process to improve velocity model anomalies even better than could be obtained with a single monitor well, or a plurality of monitor wells defining a straight line on the surface.

### Determining Moment Magnitude

Referring now to operation 208 of the method 200 shown in FIG. 2, embodiments for determining the moment magnitude of a seismic event will now be described.

The spectral amplitude at a receiver/sensor P_{R} (which is found from the motion measurement), can be related to that at the source by the following equation

$${P}_{R} ( f ) = \frac{{A}_{SR}}{r} exp ( \frac{- π f t}{{Q}_{eff}} ) T ( f ) {P}_{S} ( f ) \qquad Equation 8$$

There are 4 corrections, distance, angle, receiver response function and attenuation, and f denotes frequency, T(f) denotes the receiver response function (including sensitivity), r denotes source receiver distance, A_{SR} denotes angular correction for the source-receiver orientation, t denotes travel time from the source to the receiver, Q_{eff} denotes the layered attenuation (which for two layers may be t/Q_{eff}=t_{B}/Q_{B}+t₂/Q₂, where the subscript _{B} refers to a bentonite layer and the subscript ₂ refers to another material), and P_{S} denotes the “true” spectral amplitude at the source.

The goal is use the corrections to find the true spectral amplitude, and from that, determine the moment magnitude by integrating over time.

The function P_{S}(f) may be inverse Fourier transformed to give the velocity record at the source (u_{S}′ (t)) as a function of time. This is the time derivative of the displacement. The time derivative of the moment rate Mₒ″(t) can be determined through the velocity record by the following equation

Mₒ″(t)=4πρ_{eff}α_{eff}³u_{S}(t)′ Equation 9

In Equation 9, ρ_{eff} denotes the effective density, and α_{eff} denotes the effective p-wave velocity.

By integrating once over time and subtracting the long-time average, and then integrating once more, the moment magnitude can then be found using the following equation:

M_{w}=(⅔)log₁₀(M₀*1e7)−10.7 Equation 10

Generally any known method may be used to determine the moment magnitude of a seismic event.

### Determining Moment Tensor

Referring now to operation 210 of the method 200 shown in FIG. 2, embodiments for determining the moment tensor of a seismic event will now be described.

In some embodiments, the determination of the focal mechanism and/or moment tensor can simply be thought of as drawing a sphere around a seismic event, and for each take-off angle to a given station, placing the polarity (p-wave first motion) seen at the sensor/station (+ or −) on the sphere. The correct focal mechanism will divide the sphere into 4 quadrants, with all of the polarity types separated.

In some embodiments, a grid search over possible strike, dip and rake values may be undertaken to determine the best focal mechanism. Doing so may find the minimum-misfit solution, which may be the solution where the number of polarity observations which disagree with the quadrant in which they appear is minimized. The strike, dip, and rake are varied while keeping the number of misfits below a fixed level. This serves to determine the quality of the fault-plane solution. In some embodiments, errors in the P-wave polarities may be accounted for. Also, the possibility of errors in the velocity model and the resultant error in the source location may be considered. This may be accomplished by testing multiple combinations of reasonable locations and velocity structures, and a list of solutions which fit at least a given fraction of polarity observations can be obtained.

The first-motion analysis may include the following steps: a) use an angular grid search to find all acceptable solutions: those with misfit polarities below a fixed value, b) perturb source location, c) compute new ray azimuths and takeoff angles, d) find all acceptable solutions, e) perturb source location, and f) repeat. Multiple trials may be performed with different locations, velocities and polarities to determine acceptable mechanisms.

The inputs to the process may include azimuth to station from event (in degrees), take off angle from event to station from vertical (in degrees) which can have several “trials” which might be represented by grid points neighboring the event location, first motion of event, quality of first motion (impulsive: first motion easily determined, emergent: ambiguous first motion), number of trials, angular spacing for grid search, maximum number of fault planes to return, allowed number of misfits (first motions which are incorrect). The outputs to the process may include the number of fault planes found, strike, dip, rake, fault normal vector, slip vector, and moment tensor.

In some embodiments, the take-off angles and first motion P-polarities may be used to populate the focal sphere. Then, a search for the fault and auxiliary planes that yield the fewest misfits of polarities may be conducted. One advantage of this approach is that it allows a user-specified uncertainty in the polarity and angles, returning multiple mechanisms with associated probabilities. The complete set of mechanisms may include isotropic expansion (contraction) and compensated-linear-vector dipoles (CLVD).

Accordingly, a novel approach of some embodiments may include the following steps:
1) Sequentially searching for 2-plane (DC), 1-plane (CLVD) and 0-plane (isotropic change) solutions. The CLVD is defined by a single reflection plane and is rotationally invariant about the axis perpendicular to that plane. By searching over all possible orientations of the plane, the orientation with the fewest misfits can be found. It may be best to search using only misfits from the best DC fit. This can be extended to the 0-plane mechanism. For example, if all of the misfits from the DC have the same polarity, this may be consistent with an isotropic mechanism in addition to the DC.
2) Using the number of misfits (or some other measure) to determine the relative weights of the three mechanisms. With the relative weights the moment tensor can be determined.

While the dominant mechanism for most microseismic events is usually DC, hydro-fractures typically include at least some expansion or contraction (i.e., some volume change). The relative contribution of expansion to the moment tensor and a quantitative measure of the expansion may be valuable additions to available methods.

Another embodiment for calculating the moment tensor is to relate its components to the signal amplitudes for each direction and station. Symbolically, d=Am. Here d is a vector of the amplitudes (6n, with n the number of stations), m are the six distinct components of the moment tensor, and A is the matrix (6n×6), which relates the two vectors. This can be inverted to solve for m=A⁻¹d, using a pseudoinverse technique.

The moment tensor may be used to find the strike, dip and rake as well as the fault plane and slip vectors. For instance, the three angles determining the orientation of the eigenvectors of the moment tensor equate to the strike, dip and rake. The eigenvalues are called the principal moments and determine the mechanism. If the sum of the principal moments (Mₓ+M_{y}+M_{z}=sum of the diagonal elements) is positive, then there may be a net volume increase; if negative, a net volume decrease. A double-couple only has off diagonal elements and has no volume change.

This procedure may allow for the determination of a moment tensor with volumetric changes, which occur to some degree in hydraulic fracturing. It may, however, require knowledge of the amplitudes for all components, as opposed to only knowing the polarity of the p-wave first arrival.

The i-th component of motion from P-wave can be represented as

$${u}_{i}^{P} ( r , t ) = \frac{1}{( 4 πρ {α}^{3} )} {γ}_{i} {\sum }_{j , k} {γ}_{j} {γ}_{k} {M}_{j , k} \dot{X} ( t - \frac{r}{α} ) \qquad Equation 11$$

Similarly, the i-th component of motion from S-wave can be represented as

$${u}_{i}^{S} ( r , t ) = \frac{1}{( 4 π ρ {β}^{3} )} {\sum }_{j , k} [ {δ}_{i , j} - {γ}_{j} {γ}_{i} ] {γ}_{k} {M}_{j , k} \dot{X} ( t - \frac{r}{β} ) \qquad Equation 12$$

In Equations 11 and 12, ρ denotes density, α and β denote P-wave and S-wave velocities, respectively, M_{i,j} are the moment tensor elements, γᵢ is the direction cosine with respect to the i-th coordinate (x/r, y/r, z/r), and X is the time function.

Equations 11 and 12 can be expanded, noting the symmetry of the moment tensor, as follows:

$$\begin{matrix}{u}_{x}^{P} ( r , t ) = \frac{1}{4 π ρ {α}^{3}} {γ}_{x} \{ \begin{matrix}{γ}_{x} {γ}_{x} {M}_{1 , 1} + {γ}_{y} {γ}_{y} {M}_{2 , 2} + {γ}_{z} {γ}_{z} {M}_{3 , 3} + \\ 2 {γ}_{x} {γ}_{y} {M}_{1 , 2} + 2 {γ}_{x} {γ}_{z} {M}_{1 , 3} + 2 {γ}_{y} {γ}_{z} {M}_{1 , 3}\end{matrix} \} \dot{X} ( t - \frac{r}{α} ) & Equation 13 \\ {u}_{x}^{S} ( r , t ) = \frac{1}{4 π ρ {β}^{3}} \{ \begin{matrix}( 1 - {γ}_{x} {γ}_{x} ) {γ}_{x} {M}_{1 , 1} + ( 1 - 2 {γ}_{x} {γ}_{x} ) ( {γ}_{y} {M}_{1 , 2} + {γ}_{z} {M}_{1 , 3} ) - \\ 2 {γ}_{x} {γ}_{y} {γ}_{z} {M}_{2 , 3} - {γ}_{x} ( {γ}_{y} {γ}_{y} {M}_{2 , 2} + {γ}_{z} {γ}_{z} {M}_{3 , 3}\end{matrix} \} \dot{X} ( t - \frac{r}{β} ) & Equation 14\end{matrix}$$

The u_{y} component may be found by replacing x→y→z→x and 1→2→3→1 and again for u_{z}.

The direction cosines may be given by γₓ=sin θ cos φ, γ_{y}=sin θ sim φ, and γ_{z}=cos θ. Here θ and φ are the take-off and azimuth angles from the seismic event to the receiver.

The observed amplitudes for the arrivals at a given receiver d=(aₓ^{P}, a_{y}^{P}, a_{z}^{P}, aₓ^{S}, a_{y}^{S}, a_{z}^{S}) can be linked to the moment tensor through the relation d=Am, where the vector m=(M₁₁, M₂₂, M₃₃, M₁₂, M₁₃, M₂₃). A is the 6×6 matrix found from above:

$$A = [ \begin{matrix}{γ}_{x}^{3} & {γ}_{x} {γ}_{y}^{2} & {γ}_{x} {γ}_{z}^{2} & 2 {γ}_{x}^{2} {γ}_{y} & 2 {γ}_{x}^{2} {γ}_{y} & 2 {γ}_{x} {γ}_{y} {γ}_{z} \\ {γ}_{y} {γ}_{x}^{2} & {γ}_{y}^{3} & {γ}_{y} {γ}_{z}^{2} & 2 {γ}_{y}^{2} {γ}_{x} & 2 {γ}_{x} {γ}_{y} {γ}_{z} & 2 {γ}_{y}^{2} {γ}_{z} \\ {γ}_{z} {γ}_{x}^{2} & {γ}_{z} {γ}_{y}^{2} & {γ}_{z}^{3} & 2 {γ}_{x} {γ}_{y} {γ}_{z} & 2 {γ}_{z}^{2} {γ}_{x} & 2 {γ}_{z}^{2} {γ}_{y} \\ ( 1 - {γ}_{x}^{2} ) {γ}_{x} & - {γ}_{y}^{2} {γ}_{x} & - {γ}_{z}^{2} {γ}_{x} & ( 1 - 2 {γ}_{x}^{2} ) {γ}_{y} & ( 1 - 2 {γ}_{x}^{2} ) {γ}_{z} & - 2 {γ}_{x} {γ}_{y} {γ}_{z} \\ - {γ}_{x}^{2} {γ}_{y} & ( 1 - {γ}_{y}^{2} ) {γ}_{y} & - {γ}_{z}^{2} {γ}_{y} & ( 1 - 2 {γ}_{y}^{2} ) {γ}_{x} & - 2 {γ}_{x} {γ}_{y} {γ}_{z} & ( 1 - 2 {γ}_{y}^{2} ) {γ}_{z} \\ - {γ}_{x}^{2} {γ}_{z} & - {γ}_{y}^{2} {γ}_{z} & ( 1 - {γ}_{z}^{2} ) {γ}_{z} & - 2 {γ}_{x} {γ}_{y} {γ}_{z} & ( 1 - 2 {γ}_{z}^{2} ) {γ}_{x} & ( 1 - 2 {γ}_{z}^{2} ) {γ}_{y}\end{matrix} ] \qquad Equation 15$$

The first 3 rows may be multiplied by the factors associated with the p-wave and the second 3 rows may be multiplied by the factors associated with the s-wave. The matrix A may be extended vertically for each receiver, so there are 6n rows and 6 columns (where n=number of receivers). We can thus solve for the unknown tensor by “inverting” and multiplying the amplitudes m=A⁻¹d. This pseudo-inverse may be the same process used for the non-linear least squares location program.

In other embodiments, however, Gel Mann matrices may be used to determine the moment tensor of a seismic event, or generally any known method may be used to determine the moment tensor of a seismic event.

### Visualizing Seismic Events

Referring now to FIGS. 5A through 9, embodiments for visualizing one or more seismic events (e.g., operation 212 in the method 200 shown in FIG. 2) will now be described. There are several conventional ways to visualize a seismic event—including the location, moment magnitude, and/or the moment tensor associated with the seismic event. For example, a “beach ball” may be used to show regions of compression and expansion. As another example, a radiation pattern of the moment tensor may be used (with the radiation pattern determined by the relationship between the displacement, the direction cosines and the moment tensor). As still another example, a Hudson diagram (k-T plot) may be used to display different components of the moment tensor, where k corresponds to the degree of expansion (−1 to 1) and T corresponds to the relative sizes of the compensated linear vector dipole (CLVD) and the double couple. All of these conventional visualization techniques, however, provide a static representation of the seismic event that does not capture uncertainty in the determination of the location, moment magnitude, and/or the moment tensor.

As described in more detail below, some of the embodiments described herein provide a visual indication not only of the location, moment magnitude, and/or the moment tensor associated with a seismic event, but also a visual indication of the uncertainty of the determined location, moment magnitude, and/or moment tensor. By displaying not only the location, moment magnitude, and/or the moment tensor associated with a seismic event, but also uncertainties related to the determined location, moment magnitude, and/or moment tensor of the seismic event, scientists and engineers may be able to better understand the seismic data and the underlying seismic events.

Generally speaking, the uncertainties associated with the determined location, moment magnitude, and/or moment tensor of a seismic event may be displayed using motion and/or blurring in some embodiments described herein. In other embodiments, other methods may be used to display uncertainty associated with a parameter of a seismic event. In one example, a time-varying graphical representation may be shown on a computer display, with the graphical representation varying in time based on the uncertainty associated with one or more parameters of the seismic event. As another example, a graphical representation may include at least one feature that is blurred as a function of the uncertainty associated with one or more parameters of the seismic event.

A processor (such as CPU 311 in FIG. 3) may receive a parameter related to a seismic event (e.g., a location, a moment magnitude, a moment tensor, etc.), together with an uncertainty associated with the parameter. A display (such as the I/O device 317 in FIG. 3) may be coupled to the processor and may also be configured to provide a graphical representation of the seismic event responsive to instructions from the processor. The graphical representation may be, for example a 3-D object, such as a sphere or a radiation pattern. The processor and display may be able to provide multiple graphical representations corresponding to multiple seismic events—each graphical representation corresponding to a respective seismic event. In some embodiment, however, multiple graphical representations may correspond to a single seismic event—as explained in more detail below. Also, in some embodiments, a single graphical representation may be displayed as a function of multiple parameters and/or multiple uncertainties associated with a single seismic event—for example, if the processor receives multiple parameters and multiple uncertainties for a single seismic event, the processor may be configured to provide instructions to the display to vary the graphical representation in time based on a union of the first and second parameters with the corresponding first and second uncertainties.

In some embodiments, graphical representations corresponding to one or more seismic events may be provided on a display as the one or more seismic events occurs in real-time or in substantially real-time (e.g., within second or minutes after the occurrence of the seismic event).

FIGS. 5A through 5D illustrate one example of a graphical representation 500 for visualizing a seismic event. In FIGS. 5A through 5D, the parameter being visualized is a determined spatial position (e.g., the x, y, z coordinates of the location determined in operation 206 above) associated with the seismic event, and the graphical representation 500 varies in time by moving (e.g., bouncing) within an enclosed space 502. As shown in FIG. 5A, the enclosed space 502 may be a bounded volume, such as an ellipsoid, cube, and so forth. The enclosed space 502 may represent a bounded volume within the subsurface within which the seismic event is expected to have occurred, with the uncertainty associated with the determined spatial position of the seismic event defining the outer limits of the bounded volume.

Referring specifically to FIG. 5A, a graphical representation of the determined spatial position of the seismic event is shown in motion, varying with time. The graphical representation is a “beach ball,” and it is shown moving from a first location 504 to a second location 505 to a third location 506 within the ellipsoid 502 representing the bounded volume. As previously mentioned, the movement of the graphical representation is a function of the uncertainty of the spatial position of the seismic event, and the outer bounds of the ellipsoid 502 represent the boundaries of the space in which the event is likely to have occurred. FIGS. 5B, 5C, and 5D show snapshots of the motion depicted in FIG. 5A, with the graphical representation being at the first location 504 in FIG. 5B, at the second location 505 in FIG. 5C, and at the third location 506 in FIG. 5D. As illustrated in FIGS. 5C and 5D, in some embodiments, an indication of the graphical representation (which may be shown in a different color and/or with reduced intensity) may continuously be displayed at the center of the bounded volume 502, and may represent the most likely location for the seismic event. In other embodiments, however, no indication may be continuously displayed at the center, or the reduced-intensity indication may be displayed elsewhere within the bounded volume.

Although the graphical representations in FIGS. 5A through 5D include a so called “beach ball” (which indicates the moment tensor of the event), in other embodiments, the graphical representation may not be a “beach ball” but instead may be a different graphical indication that varies in time by moving within an enclosed space.

Turning now to FIGS. 6A through 6D, another example of a graphical representation 600 for visualizing a seismic event is shown. In FIGS. 6A through 6D, the parameter being visualized is a moment magnitude associated with the seismic event, and the graphical representation may vary in time by expanding and contracting. The amount of expansion and contraction of the graphical representation 600 may be a function of the uncertainty associated with the moment magnitude, with the average size of the graphical representation corresponding to a most likely moment magnitude associated with the seismic event.

Referring specifically to FIG. 6A, a graphical representation of the calculated moment magnitude of the seismic event is shown in motion, varying with time. The graphical representation is again a “beach ball,” and it is shown expanding from a first size 610 to a larger, second size 612. As previously mentioned, the expansion and contraction of the graphical representation is a function of the uncertainty of the moment magnitude of the seismic event, with the largest size corresponding to the largest probable value of the moment magnitude and the smallest size corresponding to the smallest probable value of the moment magnitude. FIGS. 6B, 6C, and 6D show snapshots of the motion depicted in FIG. 6A, with the graphical representation having the first size 610 in FIG. 6B, having the second, larger size 612 in FIG. 6C, and a third, smaller size 614 in FIG. 6D. In some embodiments (not shown), an indication of the most likely moment magnitude may be continuously displayed with a reduced intensity on the display. In other embodiments, no such indication may be continuously displayed. Also, although the graphical representations in FIGS. 6A through 6D include a so called “beach ball,” in other embodiments, the graphical representation may not be a “beach ball” but instead may be a different graphical indication that varies in time by varying in size.

Turning now to FIGS. 7A through 7D, another example of a graphical representation 700 for visualizing a seismic event is shown. In FIGS. 7A through 7D, the parameter being visualized is a moment tensor associated with the seismic event, and the graphical representation may vary in time by showing motion of one or more indications on, for example, a sphere. The moment tensor may be defined by a plurality of values corresponding to different types of movement, orientation, and volume change associated with the seismic event. The one or more indications may include, for example, a line, a great circle, a colored region, etc. The motion of the one or more indications on the sphere may be a function of the uncertainty associated with the moment tensor, with the middle (or average) position of the one or more indications corresponding to a most likely moment tensor associated with the seismic event. The uncertainty of the moment tensor may be determined in some embodiments by the number of sensors used to collect the seismic data, background noise, etc.

Referring specifically to FIG. 7A, a graphical representation of the determined moment tensor of the seismic event is shown in motion, varying with time. The graphical representation is again a “beach ball,” and the indications 720, 721 are shown moving across the sphere of the beach ball. As previously mentioned, the movement of the indications 720, 721 (which are, in this case, lines or great circles) is a function of the uncertainty of the moment tensor of the seismic event, with the position of the indications indicating the likely orientation of fault lines in, for example, a double couple type moment tensor. Of course, other types of moment tensors could also be displayed, including moment tensors having a plurality of different components. FIGS. 7B, 7C, and 7D show snapshots of the motion depicted in FIG. 7A, with the graphical representation in FIG. 7B showing the indications 720, 721 in a first position, the graphical representation in FIG. 7C showing the indications 720, 721 in a second position, and the graphical representation in FIG. 7D showing the indications 720, 721 again in the first position. In some embodiments (not shown), the graphical representation may include a continuously displayed indication with a reduced intensity on the display. In other embodiments, no such indication may be continuously displayed. Also, although the graphical representations in FIGS. 7A through 7D include a so called “beach ball,” in other embodiments, the graphical representation may not be a “beach ball” but instead may be a different graphical indication of the moment tensor of the seismic event—such as a radiation pattern associated with the moment tensor.

Turning now to FIG. 8, another example of a graphical representation 800 for visualizing a seismic event is shown. In FIG. 8, the parameter being visualized is a moment tensor associated with the seismic event, and the graphical representation may include a feature that is blurred (e.g., made fuzzy, or changed in color or intensity) as a function of the uncertainty associated with the determined moment tensor. The feature may include, for example, a line, a great circle, a colored region, etc. The blurring of the one or more features may be a function of the uncertainty associated with the moment tensor.

Referring specifically to FIG. 8, a graphical representation 800 of the determined moment tensor of the seismic event is shown with a plurality of blurred features. The graphical representation is again a “beach ball” with a plurality of colored regions, with several of the transitions 830, 831, 832, 833 between the colored regions blurred as a function of the uncertainty associated with the moment tensor. For example, and as illustrated in FIG. 8, the graphical representation may include one or more regions defining a first color (e.g., black) and one or more regions defining a second color (e.g., white), and the blurred transitions may define a third color (e.g., gray) that is a combination or gradational blend of the first and second colors. Alternatively, instead of colors, different textures or cross-hatching may be used. In some examples, the size (e.g., thickness) of the transition may be a function of the uncertainty associated with the moment tensor—such as an uncertainty of the orientation and location of focal planes. Also, in some examples, the graphical representation 800, or at least the blurred features of the graphical representation may not vary in time, but may be static.

It will be appreciated that the graphical representation 800 may be combined with other graphical representations representing other parameters associated with the seismic event (e.g., moment magnitude, location, etc.). For example, if the moment magnitude (and its uncertainty) and the determined location of the seismic event (and its uncertainty) are provided, the graphical representation 800 may be modified to reflect the moment magnitude and determined location, along with their uncertainties. In other words, the graphical representation 800 illustrated in FIG. 8 may expand and contract as described above with reference to FIGS. 6A through 6D, while also moving (e.g., bouncing) within an enclosed space as described above with reference to FIGS. 5A through 5D, etc.

Turning now to FIGS. 9A through 9C, in some embodiments the moment tensor may include a plurality of components 940, 941, 942 as mentioned above. In these instances, the various components 940, 941, 942 may be visualized in one of several different ways. For example, the graphical representation of the seismic event may show a first of the components 940 during a first time slot, a second of the components 941 during a second time slot, and a third of the components 942 during a third time slot. Alternatively, two or more of the components 940, 941, 942 may be translucently shown in the graphical representation. In some embodiments, different colors may be used to represent the different components 940, 941, 942, with the different colors being overlaid on one another. For example, red and white may be used for a monopole component 940, blue and white may be used for a dipole component 941, and green and white may be used for a quadrupole component 942, with the intensity of each color representing the percentage of that component to the overall moment tensor and/or an uncertainty (or probability) associated with that component.

FIG. 10 illustrates yet another example of a graphical representation 1000 of a seismic event. In FIG. 10, multiple parameters associated with a single seismic event are combined into a single graphical representation, or, stated differently, multiple graphical representations corresponding to different parameters associated with the seismic event are combined (e.g., overlaid on one another). Specifically, in FIG. 10, a beach ball is shown bouncing around in an enclosed space 1010 which may be associated with an expected location of the seismic event. The beach ball is also shown having a varying size. For example, the beach ball may vary from a first size 1021 to a second size 1022 as a function of an uncertainty in the calculation of the moment magnitude associated with the seismic event. Furthermore, the beach ball may include colored regions 1001-1004 indicating the moment tensor. In one embodiment, the transition from one colored region to another colored region may be a fuzzy transition. Alternatively, the beach ball may be shown as a ball of yarn, illustrating a plurality of acceptable focal mechanisms associated with a seismic event.

Turning now to FIG. 11, a display 1117 is shown, illustrating the visualization 1102 of a plurality of different seismic events. As shown in FIG. 11, in some embodiments, a user may be able to cause the display to selectively stop the graphical representations from varying in time with respect to one or more parameters (i.e., based on the uncertainties associated with the parameters) via a first set of controls 1122 and/or may be able to cause the display to selectively hide one or more of the plurality of graphical representations responsive to a filtering criteria via a second set of controls 1124.

In the foregoing, reference is made to embodiments of the invention. However, it should be understood that the invention is not limited to specific described embodiments. Instead, any combination of the features and elements, whether related to different embodiments or not, is contemplated to implement and practice the invention. Thus while the apparatuses and associated methods in accordance with the present disclosure have been described with reference to particular embodiments thereof in order to illustrate the principles of operation, the above description is by way of illustration and not by way of limitation. Various modifications and alterations to the described embodiments will be apparent to those skilled in the art in view of the teachings herein. Those skilled in the art may, for example, be able to devise numerous systems, arrangements and methods which, although not explicitly shown or described herein, embody the principles described and are thus within the spirit and scope of this disclosure. Accordingly, it is intended that all such alterations, variations, and modifications of the disclosed embodiments are within the scope of this disclosure.

In methodologies directly or indirectly set forth herein, various steps and operations are described in one possible order of operation, but those skilled in the art will recognize that the steps and operations may be rearranged, replaced, or eliminated without necessarily departing from the spirit and scope of the disclosed embodiments. Further, all relative and directional references used herein are given by way of example to aid the reader's understanding of the particular embodiments described herein. They should not be read to be requirements or limitations, particularly as to the position, orientation, or use of the invention unless specifically set forth in the claims.

Furthermore, in various embodiments, the invention provides numerous advantages over the prior art. However, although embodiments of the invention may achieve advantages over other possible solutions and/or over the prior art, whether or not a particular advantage is achieved by a given embodiment is not limiting of the invention. Thus, the described aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computerized system. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a wireless network. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the computer into a machine-readable format and hence executable instructions. Also, programs are comprised of variables and data structures that either reside locally to the program or are found in memory or on storage devices.

What is claimed is:

1. A method of locating a seismic event, comprising:
receiving a plurality of picked arrival times corresponding to the seismic event at a respective plurality of sensor locations;
constructing a first system of equations for locating the seismic event based on a plurality of calculated travel times derived from an estimated velocity model and the plurality of picked arrival times;
constructing a second system of equations for locating the seismic event based on
relative differences between two or more picked arrival times of the plurality of picked arrival times, the two or more picked arrival times corresponding to two or more of the plurality of sensor locations and
relative differences between two or more calculated travel times of the plurality of calculated travel times, the two or more calculated travel times corresponding to two or more of the plurality of sensor locations; and
simultaneously solving the first and second systems of equations to determine a location of the seismic event.

2. The method of claim 1, wherein the first and second systems of equations are simultaneously solved to reduce residual differences between the plurality of picked arrival times and the plurality of calculated travel times associated with the first system of equations, as well as residual differences between the two or more picked arrival times of the plurality of picked arrival times corresponding to two or more of the plurality of sensor locations and the two or more calculated travel times of the plurality of calculated travel times corresponding to two or more of the plurality of sensor locations associated with the second system of equations.

3. The method of claim 2, wherein the first and second systems of equations are simultaneously solved by iteratively changing a proposed location for the seismic event until a change in the residual differences is less than a threshold.

4. The method of claim 1, wherein the first and second systems of equations are simultaneously solved to minimize residual differences between the plurality of picked arrival times and the plurality of calculated travel times associated with the first system of equations, as well as residual differences between the two or more picked arrival times of the plurality of picked arrival times corresponding to two or more of the plurality of sensor locations and the two or more calculated travel times of the plurality of calculated travel times corresponding to two or more of the plurality of sensor locations associated with the second system of equations.

5. The method of claim 1, wherein the first and second systems of equations are simultaneously solved for a single seismic event at a time.

6. The method of claim 1, further comprising weighting the first and second systems of equations for respective influences of the first and second systems of equations on the determined location.

7. The method of claim 1, wherein the location of the seismic event includes an absolute position within a subsurface region and an origin time.

8. The method of claim 1, wherein the plurality of picked arrival times correspond to a plurality of observed arrival times at the plurality of sensor locations.

9. The method of claim 1, wherein the first system of equations represents an absolute seismic event locator, and the second system of equations represents a relative seismic event locator.

10. The method of claim 9, wherein the first system of equations corresponds to a single difference locator and the second system of equations corresponds to a reverse double difference locator.

11. The method of claim 1, wherein the plurality of sensor locations are located in a plurality of wellbores, the plurality of wellbores forming a buried array.

12. The method of claim 1, wherein the first system of equations is represented by a first matrix, the second system of equations is represented by a second matrix, further comprising combining the first and second matrices into a combined matrix before said simultaneous solving.

13. The method of claim 12, wherein the first and second systems of equations are weighted by multiplying the combined matrix by a diagonal weighting matrix.

14. The method of claim 1, wherein said simultaneous solving to determine the location of the seismic event is done in substantially real time relative to the seismic event.

15. The method of claim 1, wherein the two or more of the plurality of sensor locations corresponding to the two or more calculated travel times are the same as the two or more of the plurality of sensor locations corresponding to the two or more picked arrival times.

16. A method of locating a seismic event, comprising:
combining a single difference seismic locator and a reverse double difference seismic locator into a combined system of equations; and
solving the combined system of equations to determine a location of the seismic event in substantially real time relative to the seismic event;
wherein the combined system of equations is weighted such that the determined location of the seismic event is partially influenced by the single difference seismic locator and partially influenced by the reverse double difference seismic locator.

17. The method of claim 16, wherein the reverse double difference seismic locator influences the determined location of the seismic event based on relative differences between picked arrival times and calculated travel times for two or more of a plurality of seismic sensors positioned proximate one another.

18. The method of claim 17, wherein the plurality of seismic sensors are positioned in a vertical wellbore, a first of the plurality of seismic sensors is positioned no more than 20 meters away from a second of the plurality of seismic sensors, and a third of the plurality of seismic sensors is positioned no more than 20 meters away from the second of the plurality of seismic sensors.

19. The method of claim 16, further comprising displaying a graphical representation of the seismic event that varies in time based on an uncertainty associated with the determined location of the seismic event, the graphical representation varying in time by moving within an enclosed space representing a bounded volume in which the seismic event is expected to have occurred based on the determined location and the uncertainty.

20. A method of locating a seismic event, comprising:
receiving a plurality of picked arrival times corresponding to the seismic event at a respective plurality of sensor locations, the plurality of sensor locations defining a 3-D buried array;
calculating a plurality of travel times derived from an estimated velocity model;
constructing a system of equations for locating the seismic event based on
relative differences between two or more picked arrival times of the plurality of picked arrival times, the two or more picked arrival times corresponding to two or more of the plurality of sensor locations and
relative differences between two or more calculated travel times of the plurality of calculated travel times, the two or more calculated travel times corresponding to two or more of the plurality of sensor locations; and
solving the systems of equation to determine a location of the seismic event.
